(19) United States
(12) Patent Application Publication
(10) Pub. No.: US 2005/0069667 A1
(43) Pub. Date: Mar. 31, 2005

(54) Method for attachment of tire pressure sensor

(76) Inventor: Carl E. Wacker, Rochester Hills, MI (US)

Correspondence Address: BRINKS HOFER GILSON & LIONE, P.O. BOX 10395, CHICAGO, IL, 60610, US

(21) Appl. No.: 10/678,036

(22) Filed: Sep. 30, 2003

(51) Int. Cl. B32B 9/00

(52) U.S. Cl. 428/40.1; 428/343

(57) ABSTRACT

Provided is a method for attaching a tire pressure sensor to a vehicle tire, where an adhesive region is exposed on a tire pressure sensor, and the tire pressure sensor is attached to a tire. The adhesive region is made of a first and second adhesive, where the first adhesive has a short cure time, and the second adhesive has a cure time longer than that of said first adhesive, and an adhesive strength greater than that of said first adhesive. Also provided is an adhesive system for a tire pressure sensor, where an adhesion surface on the tire pressure sensor is made of an outer perimeter and an inner region. The first adhesive has a short cure time, while the second adhesive has a long cure time and an adhesive strength greater than that of the first adhesive. Also provided is a tire sensor that can be mounted to a vehicle wheel, where the tire sensor includes a housing including an adhesion surface, with adhesive material disposed upon the adhesion surface. The adhesive material includes a first, relatively fast curing adhesive and a second, relatively strong operating adhesive. The first adhesive area retains the tire sensor during mounting on a mounting surface of the wheel while the second adhesive area cures to a relatively strong adhesive strength.

### BACKGROUND

The present invention relates generally to adhesive bonding of one item to another item. More particularly, the present invention relates to a method for adhesive attachment of a tire pressure sensor.

In industries where a final product is assembled via the use of an assembly line, time is a precious commodity. Often, various portions of the final product need to be assembled in only a matter of seconds. Not only do these parts need to be attached to the final product quickly, but they also need to be attached securely, so that the part will not disengage from the rest of the product during the remainder of the assembly process or during use of the final product.

In the assembly of a vehicle, these concerns are even more critical. As the final product often travels at high rates of speed, a secure assembly is extremely important such that parts of the vehicle do not disengage during use. For example, a tire pressure sensor is often attached to the wheel or rim of a vehicle. An assembly line worker, on average, often has less than 10 seconds to attach such a sensor to each of the four or more wheels of the vehicle. Each of these sensors must be attached precisely, so that it will function properly in reading the tire pressure. Each sensor must also be attached securely, so that the sensor does not disengage from the tire due to assembly stresses or due to centripetal force during vehicle use. However, time constraints require that the sensors be attached very quickly so that the attachment operation does not interfere with or delay other assembly operations.

Commonly, tire pressure sensors have been attached using a “snap on” system. A “snap on” system, such as that disclosed in U.S. Pat. No. 6,005,480 and incorporated by reference in the present application, uses a hole in the wheel rim to frictionally engage the tire pressure sensor with the vehicle wheel. However, for larger or heavier tire pressure sensors, this method is ineffective, as the tire sensor will disengage from the frictional attachment upon use of the vehicle at a high speed.

More commonly prevalent is a “clamp in” tire pressure sensor. A “clamp in” system, such as that disclosed in FIGS. 2 and 3 of U.S. Pat. No. 5,600,301 and incorporated by reference in the present application, physically clamps the tire pressure sensor on to the wheel rim. While this method gives a more secure fit, a “clamp in” system is more expensive to implement due to the cost of additional assembly pieces and additional labor. Further, the “clamp in” method significantly slows down the assembly line process.

Adhesives have not been used in this process. Those adhesives that would be strong enough to keep a vehicle sensor attached to the tire throughout the assembly process and everyday use of the vehicle require a long cure time of at least about 6 to about 12 hours. Such adhesives require an assembly line worker or assembly line equipment to hold together the sensor and the surface to which it will be adhering for periods of at least about 10 to about 15 minutes. This slows and interferes with the overall vehicle assembly, which is not acceptable. Adhesives that would cure in the seconds that the assembly worker has to attach the tire sensor would not be strong enough to assure that the tire sensor will not disengage from the tire during assembly, let alone during use.

### BRIEF SUMMARY

Accordingly, in one embodiment, there is provided a method for attaching a tire pressure sensor to a vehicle tire. An adhesive region is exposed on a tire pressure sensor. This adhesive region has first and second adhesive areas. The first adhesive area has a first adhesive with relatively short cure time. The second adhesive area has a second adhesive with a cure time longer than that of the first adhesive, and an adhesive strength greater than the adhesive strength of the first adhesive. The tire pressure sensor is then attached to said vehicle tire.

According to another embodiment, there is provided an adhesive system for a tire pressure sensor comprising an adhesion surface on the tire pressure sensor. The adhesion surface has an outer perimeter and an inner region. A first adhesive is located on the adhesion surface, the first adhesive having a relatively short cure time. A second adhesive is also located on the adhesion surface. The second adhesive has a relatively long cure time and an adhesive strength greater than that of said first adhesive.

According to yet another embodiment of the present invention, there is provided a tire sensor mountable to a wheel of a vehicle, the tire sensor comprising a housing including an adhesion surface. Adhesive material is disposed on the adhesion surface, the adhesive material including a first adhesive area having a relatively fast curing adhesive and a second adhesive area having a relatively strong operating adhesive, the first adhesive area retaining the tire sensor during mounting on a mounting surface of the wheel while the second adhesive area cures to a relatively strong adhesive strength.

Other aspects of the present invention will become apparent in connection with the following description of the present invention. The foregoing discussion of the preferred embodiments has been provided only by way of introduction. Nothing in this section should be taken as a limitation on the following claims, which define the scope of the invention.

### BRIEF DESCRIPTION OF THE DRAWINGS

FIG. 1 is a flow diagram of the method of the present invention;

FIG. 2A is a view of an embodiment of an adhesive surface of the present invention;

FIG. 2B is a view of an embodiment of the adhesive system of the present invention;

FIG. 3A is a side view of an embodiment of the tire pressure sensor of the present invention; and

FIG. 3B is a view of an embodiment of the tire pressure sensor of the present invention as attached to a vehicle wheel.

### DETAILED DESCRIPTION OF THE DRAWINGS AND THE PRESENTLY PREFERRED EMBODIMENTS

An assembly worker typically has a matter of seconds to attach a tire sensor to all tires or wheels on a vehicle. Preferably, an assembly worker has about 10 seconds or less to ensure that a tire sensor has been properly and permanently affixed to each wheel of a vehicle. FIG. 3A shows one embodiment of a tire pressure sensor 15 as disposed on a wheel 16 of a vehicle. The surface of the wheel 16 where it is contacted by the tire pressure sensor 15 is called an adhesion surface.

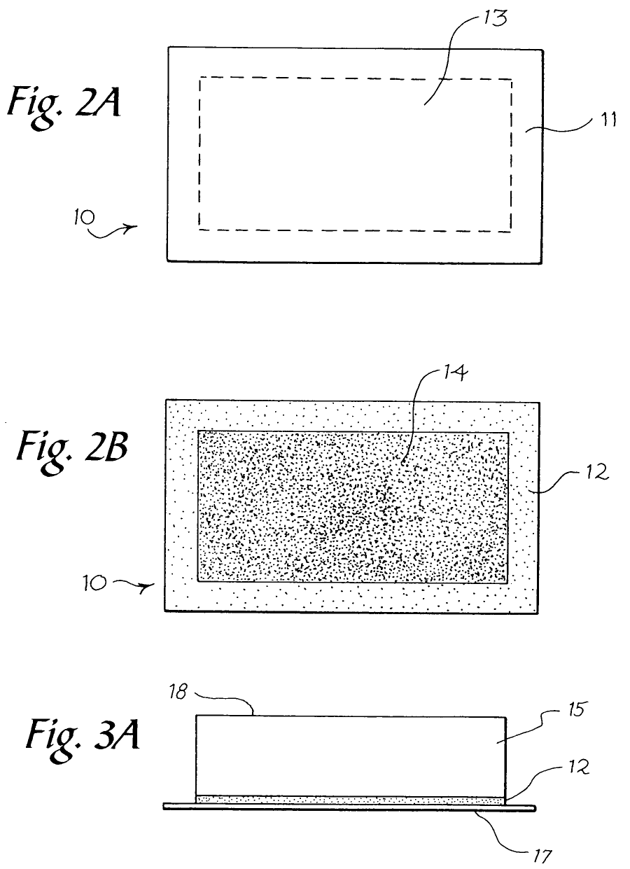

FIG. 2A is a more detailed depiction of this surface. An adhesive surface 10 is chosen on a tire sensor as the point where adhesion is to occur. The adhesive surface 10 of FIG. 2A is depicted as a generally quadrilateral area, but may be of any shape necessary to promote adhesion of the tire sensor to the tire. Further, the adhesive surface 10 may encompass an entire side of the tire sensor, or may encompass only a portion of a side as necessary in the application. Adhesives are then placed on the adhesive regions of FIG. 2A, resulting in the representative adhesive surface 10 of FIG. 2B.

A first adhesive area 11 is composed of a first adhesive 12 with a relatively short cure time. Preferably, the cure time of the first adhesive 12 is less than about ten seconds; more preferably, the cure time of the first adhesive 12 is less than about five seconds. Any adhesive known in the art to have a short cure time may be used. For example, and without limitation, cyanoacrylates or isocyanates may be used as first adhesives 12.

A second adhesive area 13 is composed of a second adhesive 14 with a relatively long cure time. The second adhesive 14 should have a cure time greater than that of the first adhesive 12. Preferably, however, the second adhesive 14 should have a cure time of no more than about 12 hours; more preferably, the second adhesive should have a cure time of no more than about 6 hours. The second adhesive 14 should have a relatively high adhesion strength upon curing; preferably, the adhesion strength of the second adhesive 14 should be greater than about the adhesion strength of the first adhesive 12. More preferably, the adhesion strength of the second adhesive 14 should be at least enough to solidly hold the tire pressure sensor to the wheel of the vehicle indefinitely at speeds of up to about 200 miles per hour. Further, the adhesive must have enough strength to overcome the centripetal force created by the rotational speed of the wheel and the mass of the tire pressure sensor device. Any adhesive known in the art to have a long cure time and a high adhesion strength may be used. For example, and without limitation, polyurethane or nitrile rubber based adhesives may be used as second adhesives 14.

In the illustrated embodiment of FIG. 2B, the first adhesive 12 is disposed around the second adhesive 14, on the outer perimeter of adhesive surface 10. The second adhesive 14 is preferably disposed on the inner region of the adhesive surface 10. However, the first adhesive 12 and second adhesive 14 may be switched, or the first adhesive 12 only placed upon the corners or any other portion of the adhesive surface 10, as is necessary to assure adhesion of the tire sensor to a tire. Preferably, the second adhesive 14 is placed on any region of the adhesive surface 10 not covered by the first adhesive 12.

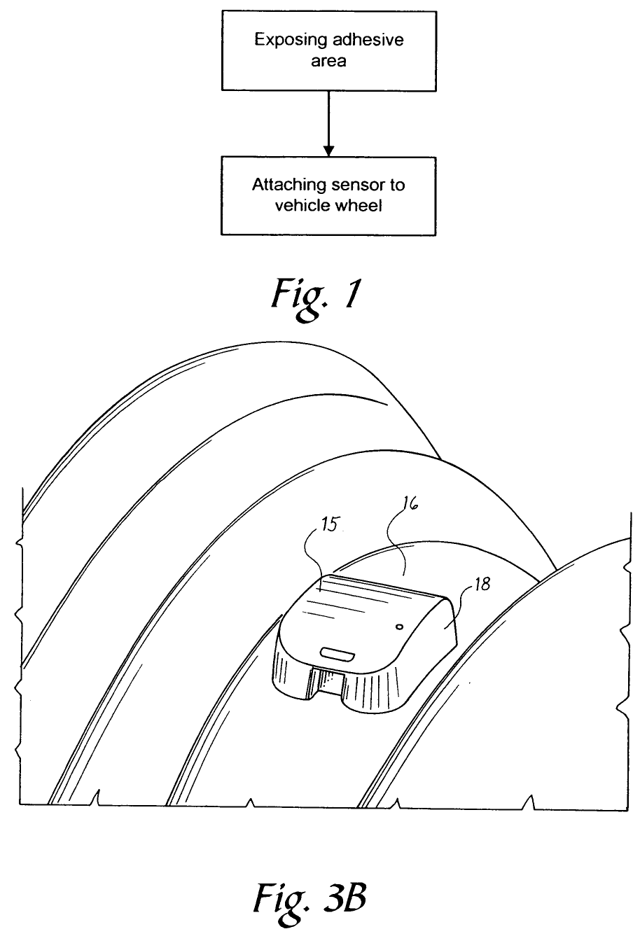

FIG. 1 is a flow diagram of one embodiment of the attachment method of the present disclosure. First, an adhesive surface is exposed at Box 100. Preferably, the first adhesive 12 and second adhesive 14 are disposed on the adhesive surface 10 of the tire pressure sensor 15 prior to assembly, and remain covered or unexposed until an assembly worker is ready to assemble the tire pressure sensor to the tire. FIG. 3A shows one embodiment of a tire sensor 15. The tire pressure sensor 15 includes a housing 18 containing a tire pressure sensing circuit, as is known in the art. The tire pressure sensor 15 has adhesives 12, 14 disposed on adhesive regions 11, 13 of the adhesive surface 10, located on the housing 18 of the tire pressure sensor.

An adhesive backing 17, as is known in the art and depicted in FIG. 3A, may be used to cover the first adhesive 12 and second adhesive 14, and protect the adhesives during shipping and storage. This adhesive backing 17 serves not only to keep the adhesive 12 and 14 contaminant-free until it is used, but also allows for the adhesive 12 and 14 to be disposed on the adhesive surface 10 in advance of use and in a uniform amount and thickness. By having the proper amount of adhesive ready for use upon removal of the adhesive backing 17, the time required to perform this step of the method is reduced. In the particular embodiment of FIG. 3A, a tire pressure sensor 15 is assembled with an adhesive 12 and 14 disposed on adhesive regions 11 and 13, and an adhesive backing 117 disposed on the tire pressure sensor 15. The tire pressure sensor 15, along with other tire pressure sensors for a vehicle, is shipped to the vehicle assembly plant with the adhesive backing 17 in place. At the time of assembly of the tire sensor to the wheel rim, the adhesive backing 17 is peeled away, exposing both the first adhesive 12 and the second adhesive 14.

The second step of the method, as illustrated at Box 110 in FIG. 1, is to attach the tire pressure sensor 15 to the vehicle wheel. A tire pressure sensor 15 as attached to a vehicle wheel 16 is depicted in FIG. 3B. The short cure time of the first adhesive 12 allows it to make a secure connection with the vehicle wheel 16 in a very short amount of time. The first adhesive 12 is able to hold the tire pressure sensor 15 to the vehicle wheel 16 securely enough to allow the second adhesive 14 to be in contact with the vehicle wheel and to cure thereon. The first adhesive 12 therefore acts as the force to hold together the tire pressure sensor 15 and the vehicle wheel 16 while allowing the curing and bonding of the second adhesive 14 to the vehicle wheel 16.

In the exemplary embodiment of FIG. 3B, the tire pressure sensor 15 is attached to the vehicle wheel 16 itself. The adhesives 12, 14 are selected for use in conjunction with the metal wheel and may be specifically chosen for the particular metal (aluminum, steel, etc.) of the wheel. This is particularly useful in embodiments in which the tire pressure sensor and the valve stem are incorporated in the same unit, so that the tire pressure sensor 15 is attached to the wheel at a position in which the valve stem extends through a hole in the wheel. In other embodiments, the tire pressure sensor 15 is attached to the inside of the tire, such as on the side wall of the tire. In this embodiment, the adhesives 12, 14 are selected for attachment to the rubber tire or other material lining the tire at the attachment point.

Preferably, this method is performed on all tires of a vehicle, either simultaneously by a number of assembly line workers, or in rapid succession by a single assembly line worker. Preferably, the attachment method herein described can be accomplished on all wheels of a vehicle in less than about ten seconds.

The embodiments of the present invention disclosed allow for a secure, reliable, and simple method of attaching a tire pressure sensor to a vehicle wheel. Removing an adhesive backing and pressing the tire pressure sensor to the wheel wall is easier and more accurate than a snap-on or clamp-on system. Two regions of adhesive allow for a reasonably secure attachment of the tire pressure sensor to the vehicle wheel while the stronger, more secure adhesive cures. Such a method can easily be performed in an assembly line situation within the short period of time allowed for sensor attachment.

Although the invention herein has been described in connection with the embodiment of attaching tire pressure sensors to a vehicle wheel, it will be appreciated by those of skill in the art that the method and adhesive described herein may be used in other assembly line applications where an adhesive is to be used, without departing from the spirit and scope of the invention as defined in the appended claims.

Although the invention herein has been described in connection with a preferred embodiment thereof, it will be appreciated by those skilled in the art that additions, modifications, substitutions, and deletions not specifically described may be made without departing from the spirit and scope of the invention as defined in the appended claims.

1. A method for attaching a tire pressure sensor to a vehicle tire, the method comprising:
exposing an adhesive area on the tire pressure sensor, said adhesive area including:
a first adhesive area, said first adhesive area including a first adhesive with a relatively short cure time; and
a second adhesive area, said second adhesive area including a second adhesive with a cure time longer than the cure time of said first adhesive, and an adhesive strength greater than adhesive strength of said first adhesive; and
attaching said tire pressure sensor to said vehicle wheel.

2. The method of claim 1, wherein said step of exposing said adhesive area comprises removing an adhesive backing from a portion of said tire pressure sensor covering said first adhesive and said second adhesive.

3. The method of claim 1, wherein the cure time of said first adhesive is less than about 10 seconds.

4. The method of claim 3, wherein the cure time of said first adhesive is less than about 5 seconds.

5. The method of claim 1, wherein the cure time of said second adhesive is greater than the cure time of said first adhesive.

6. The method of claim 5, wherein the cure time of said second adhesive is less than about 12 hours.

7. The method of claim 1, wherein said method is performed substantially simultaneously on all wheels of a vehicle.

8. The method of claim 7, wherein said method is able to be completed in less than about 10 seconds.

9. The method of claim 1, wherein said method is performed sequentially on all wheels of a vehicle.

10. A method for attaching a first surface and a second surface, said method comprising:
exposing an adhesive surface on said first surface, said adhesive surface comprising:
a first adhesive area, said first adhesive area comprising a first adhesive with short cure time; and
a second adhesive area, said second adhesive area comprising a second adhesive with a cure time longer than that of said first adhesive, and an adhesive strength greater than that of said first adhesive; and
attaching said first surface to said second surface.

11. An adhesive system for a tire pressure sensor comprising:
an adhesion surface on said tire pressure sensor, said adhesion surface comprising a first region and a second region;
a first adhesive located on said first region of said adhesion surface, said first adhesive having a short cure time; and
a second adhesive located on said second region of said adhesion surface, said second adhesive having a long cure time.

12. The adhesive system of claim 11, wherein said first region of said adhesion surface comprises the outer perimeter of said adhesive surface.

13. The adhesive system of claim 12, wherein said second region of said adhesive surface comprises the inner region of said adhesive surface.

14. The adhesive system of claim 11, wherein the cure time of said first adhesive is less than about 10 seconds.

15. The adhesive system of claim 11, wherein the cure time of said second adhesive is less than about 12 hours.

16. The adhesive system of claim 11, wherein said first adhesive is located on the first region of said adhesion surface.

17. The adhesive system of claim 16, wherein said second adhesive is located on the second region of said adhesion surface.

18. The adhesive system of claim 11, further comprising a removable backing located on top of said adhesive surface, said first adhesive, and said second adhesive.

19. A tire sensor mountable to a wheel of a vehicle, the tire sensor comprising:
a housing including an adhesion surface; and
adhesive material disposed on the adhesion surface, the adhesive material including a first adhesive area having a relatively fast curing adhesive and a second adhesive area having a relatively strong operating adhesive, the first adhesive area retaining the tire sensor during mounting on a mounting surface of the wheel while the second adhesive area cures to a relatively strong adhesive strength.

20. The tire sensor of claim 19 further comprising:
a removable adhesive backing covering the first adhesive area and the second adhesive area prior to mounting of the tire sensor on the wheel.
